(19) United States
(12) Patent Application Publication
(10) Pub. No.: US 2016/0203489 A1
(43) Pub. Date: Jul. 14, 2016

(54) METHODS, SYSTEMS, AND APPARATUS FOR IDENTIFYING RISKS IN ONLINE TRANSACTIONS

(71) Applicant: ALIBABA GROUP HOLDING LIMITED, George Town (KY)

(72) Inventors: Wei WANG, Beijing (CN); Shumin LIN, Beijing (CN)

(73) Assignee: ALIBABA GROUP HOLDING LIMITED

(21) Appl. No.: 14/993,862

(22) Filed: Jan. 12, 2016

(30) Foreign Application Priority Data
Jan. 14, 2015 (CN) 201510019448.2

(51) Int. Cl. G06Q 20/40; G06F 21/62; G06Q 30/06; H04L 29/06; H04L 29/08; G06Q 30/00

(52) U.S. Cl. CPC G06Q 20/4016; H04L 67/22; G06Q 30/018; G06Q 30/0609; H04L 63/102; H04L 63/108; H04L 63/0876; G06F 21/6245; H04L 63/1416

(57) ABSTRACT

A method for identifying risks in online transactions is provided. The method includes recording a corresponding relation between an identification of a terminal device and an account after the terminal device logs in the account, calculating a total number of different accounts logged in by the terminal device within a first predetermined period of time, based on the corresponding relation, and calculating, based on the total number of different accounts, a transaction risk value representing a transaction risk of using the terminal device to perform an online transaction.

### CROSS REFERENCE TO RELATED APPLICATION

The present application claims the benefits of priority to Chinese Application No. 201510019448.2, filed Jan. 14, 2015, the entire contents of which are incorporated herein by reference.

### TECHNICAL FIELD

The present application relates to computer network technologies, and more particularly, to methods, systems, and apparatus for identifying risks in online transactions.

### BACKGROUND

Nowadays electronic commerce (e-commerce), as a new way of shopping, has been generally accepted and widely used. As a result, internet-based transactions have become more frequent. In addition, as smart mobile devices become popular, more people have started using internet-accessible (mobile) device terminals to perform transactions, which may become the most dominant way for payment in the near future.

Meanwhile, as the total transaction amount conducted over the internet grows, transaction security becomes an issue. Due to possibilities of hacking or many other ways of illegally taking possession of other people's assets online, it has been extremely challenging for online payment and finance service providers to preemptively identify all potential threats. It is therefore important to develop technologies that can secure online transactions and eliminate potential breaches.

Existing online transaction security practices of traditional financial organizations usually involve authenticating an identification of an account by using a security digital certificate. This causes burden to users and is often user unfriendly.

### SUMMARY

One aspect of the present disclosure is directed to a method for identifying risks in online transactions. The method includes recording a corresponding relation between an identification of a terminal device and an account after the terminal device logs in the account, calculating a total number of different accounts logged in by the terminal device within a first predetermined period of time, based on the corresponding relation, and calculating, based on the total number of different accounts, a transaction risk value representing a transaction risk of using the terminal device to perform an online transaction.

Another aspect of the present disclosure is directed to an apparatus for identifying risks in online transactions. The apparatus includes a recording module configured to record an identification of the terminal device and a corresponding relation between the identification and an account after the terminal device logs in the account, a total number of different accounts statistic module configured to calculate a total number of different accounts logged in by the terminal device within a first predetermined period of time, based on the corresponding relation, and a transaction risk calculation module configured to calculate, based on the total number of different accounts, a transaction risk value representing a transaction risk of using the terminal device to perform an online transaction.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 is a flow diagram illustrating a method for identifying risks in online transactions, according to an exemplary embodiment.

FIG. 2 is a flow diagram illustrating another method for identifying risks in online transactions according to an exemplary embodiment.

FIG. 3 is a graphical representation illustrating a function for identifying risks in online transactions, according to an exemplary embodiment.

FIG. 4 is a graphical representation illustrating another function for identifying risks in online transactions, according to an exemplary embodiment.

FIG. 5 is a graphical representation illustrating another function for identifying risks in online transactions, according to an exemplary embodiment.

FIG. 6 is a flow diagram illustrating another method for identifying risks in online transactions, according to an exemplary embodiment.

FIG. 7 is a block diagram illustrating an apparatus for identifying risks in online transactions, according to an exemplary embodiment.

FIG. 8 is a block diagram illustrating another apparatus for identifying risks in online transactions, according to an exemplary embodiment.

FIG. 9 is a block diagram illustrating another apparatus for identifying risks in online transactions, according to an exemplary embodiment.

### DETAILED DESCRIPTION

Reference will now be made in detail to exemplary embodiments of the invention, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

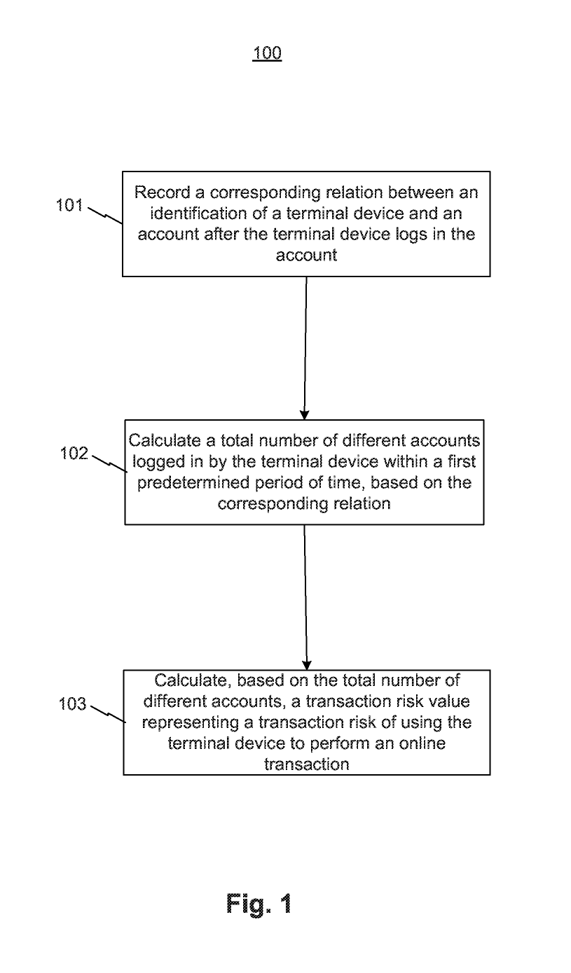

Consistent with some embodiments, the present disclosure provides a method for online transaction risk identification based on a computer system. FIG. 1 is a flow diagram of the method 100 for online transaction risk identification based on a computer system.

As shown in FIG. 1, for example, the method for online transaction risk identification based on a computer system includes the following steps:

Step 101: collect and/or record a corresponding relation between an identification of a terminal device and an account after the terminal device logs in the account. The recording may be achieved via a webpage (e.g., a browser) or a mobile device.

The identification of the terminal device may be implemented in various forms, as long as it can uniquely identify one terminal device, for example, a Media Access Control (MAC) address, a User Machine Identification (UMID) code, a Terminal Identification (TID) code, an identifier allocated to the terminal device by an application (APP) installed on the terminal device, a Subscriber Identity Module (SIM) card number, a processor identifier, a main board identifier, etc. . . .

The terms of the MAC address, the UMID code, and the TID code are explained as follows:

MAC Address: Media Access Control address, or called a hardware address, is used for defining a location of a network device. In a network protocol OSI model, the Layer 3 Network Layer is responsible for IP address, whereas the Layer 2 Data Link Layer is responsible for MAC address. Thus, one host has one IP address, whereas each network location has a unique MAC address.

UMID Code: User Machine Identification code is used for providing an accurate authentication service on an identification of a user machine.

TID Code: Terminal Identification is used for providing an accurate identification service on a user's App environment.

For example, to control risks, web browsers or cell phone clients can collect user device's finger print information, and encode the information for storage and recording (in which the internet generally uses, for example, MAC address, UMID code, TID code, etc.). The users operation (which is not limited to a transaction) corresponding to an event in a system, and all relevant information involved in the event, such as a user name, an operation name, a device code of the device used (such as MAC address, UMID code, or TID code, etc.), and so on, can be recorded and stored.

Step 102: calculate a total number of different accounts logged in by the terminal device within a first predetermined period of time, based on the corresponding relation(s).

Step 103: calculate, based on the total number of different accounts, a transaction risk value representing a transaction risk of using the terminal device to perform an online transaction.

Once the transaction risk value is calculated, it not only can be used for online transaction, but also can be used for creating an online transaction blacklist, making credit assessment, and so on. For example, when the transaction risk value is used for creating an online transaction blacklist, for a plurality of terminal devices, a transaction risk value is respectively calculated for each of the terminal devices by using the method disclosed in the embodiments of the present disclosure; next, an identification of each terminal device with a transaction risk value higher than a preset threshold is obtained; and then, an online transaction blacklist is created. Thus, the terminal devices listed in the backlist will be rejected when performing online transactions.

In this embodiment, by means of information analysis and data modeling on internet terminal devices used in online transactions, the system can identify a risk value in the online transactions and fund management, and that can help guarantee users' fund security in online shopping or financing during the users' normal usage.

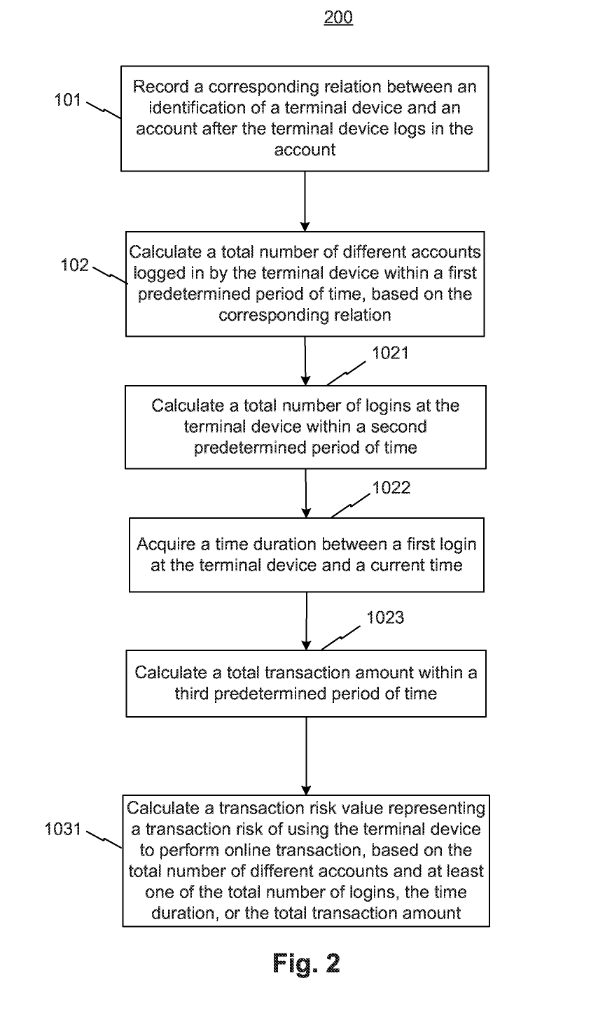

Consistent with some other embodiments, the present disclosure provides a method for online transaction risk identification based on a computer system. FIG. 2 is a flow diagram of the method 200 for online transaction risk identification based on a computer system.

In these embodiments, besides a total number of different accounts, the computer system may further analyze a total number of logins of the terminal device within one time period, a total transaction amount, a time duration from the first login to a current time, thereby obtaining a more accurate transaction risk value. For example:

Before Step 103, the method further includes the following steps:

Step 1021: calculate a total number of logins at the terminal device within a second predetermined period of time;

Step 1022: acquire a time duration between a first login at the terminal device and a current time;

Step 1023: calculate a total transaction amount within a third predetermined period of time.

Correspondingly, Step 103 further includes a Sub-step 1031: calculate a transaction risk value representing a transaction risk of using the terminal device to perform an online transaction, based on the total number of different accounts and at least one of the total number of logins, the time duration, or the total transaction amount.

For example, the above Step 1021 to Step 1023 are not indispensable. Instead, they may be executed depending upon the total number of logins, the time duration, or the total transaction amount selected in any combination with the total number of different accounts. Moreover, the sequence thereof may not be fixed either. Therefore, any combination of the above steps and the execution sequence thereof all fall within the protection scope of the present application.

In this embodiment, besides the total number of different accounts, the system may further analyze the total number of logins of the terminal device within one time period, the total transaction amount, and the time duration from the first login to a current time, so that the obtained transaction risk value is more accurate.

In addition, the method can further control the risks by performing a short message service (SMS) code authentication on each transaction, or making strict authority control on the terminal devices without installing digital certificates.

Consistent with some other embodiments, the present disclosure provides another method for online transaction risk identification based on a computer system. In these embodiments, the computer system may comprehensively consider the total number of different accounts of the terminal device, the total number of logins and the total transaction amount circulated within one time period, and the time duration from the first login to a current time, and may further considering a different weight of each of the above factors in calculating the transaction risk value, so that the calculated transaction risk value is more proper for the actual situation. For example:

In Step 1031, calculate a transaction risk value based on Equation (1).

$$Score = \frac{{a}_{1} \cdot {f}_{1} ( F ) + {a}_{2} \cdot {f}_{2} ( R ) + {a}_{3} \cdot {f}_{3} ( M )}{b \cdot {f}_{0} ( U )} \qquad ( 1 )$$

In Equation (1), ƒ₁(F) and a₁ respectively represent a function of a total number of logins F and a weight thereof, ƒ₂(R) and a₂ respectively represent a function of a time duration It and a weight thereof, ƒ₃(M) and a₃ respectively represent a function of a total transaction amount M and a weight thereof, and ƒ₀(U)and b respectively represent a function of a total number of different accounts U and a weight thereof. In applications, when a certain factor is more important compared with the other factors, its weight can be set correspondingly. In one exemplary embodiment, a₁, a₂, a₃, and b are all 1, and ƒ₁(F), ƒ₂(R), and ƒ₃(M) are all normalization functions.

For example, the total number of different accounts on a certain device is can be for example 1 to 2, which is reasonable. If the device has too many accounts, it indicates that the device has a poor privacy feature, and even has a risk of being used maliciously.

For example, in the step of calculating the transaction risk value based on Equation (1), ƒ₀(U) is an exponential function ƒ₀(U)=pow (1.2, U−1 in which U represents a total number of different accounts, 1.2 is a base of the exponential function, and U−1 is an exponent of the exponential function.

As an example, ƒ₀(U) may also be represented in other ways, which can also represent that the device has a lower risk when the total number of different accounts falls within a certain scope, for example, but not limited to, ƒ₀(U)=ax²+bx+c

In addition, the statistic data shows, the login activities of terminal devices fall within a certain scope; if the terminal device has a too low total number of logins, it implies that the terminal device is not frequently used, and if the terminal device has a too high total number of logins, it implies that the terminal device may be maliciously used.

Considering the above situations, for example, the step of calculating the transaction risk value based on Equation (1) may further include a following sub-step:

using a Chi-square distribution density curve function

$${f}_{k} ( x ) = \frac{{( 1 / 2 )}^{k / 2}}{Γ ( k / 2 )} {x}^{k / 2 - 1} {e}^{- x / 2}$$

to perform normalization on the total number of logins.

In this case, in Equation (1), ƒ₁(F) is

$${f}_{1 k} ( F ) = \frac{{( 1 / 2 )}^{k / 2}}{Γ ( k / 2 )} {F}^{k / 2 - 1} {e}^{- F / 2} ;$$

wherein, k represents a degree of freedom, F represents a total number of logins, and Γ represents Gamma function.

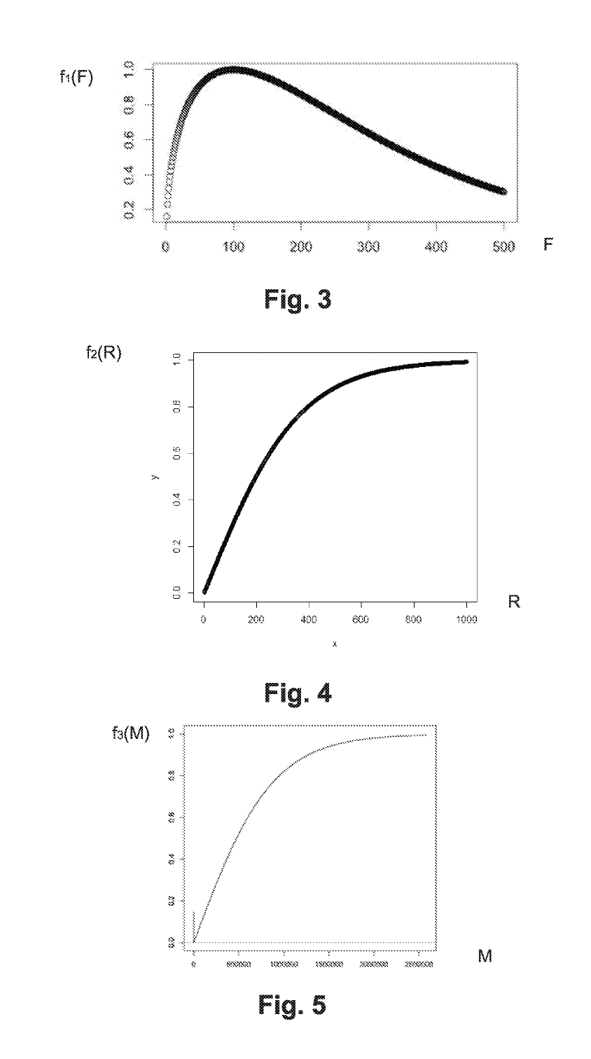

In one embodiment, it sets the degree of freedom k=3, and statistically collects a total number of logins on the terminal device by users within 90 days, and a normalization curve is shown in FIG. 3. When the users' total number of logins reaches about 90 times, the normalization risk value approaches 1.0, whereas when the total number of logins becomes lower or higher, the corresponding normalization risk value becomes smaller.

The normalization of the total number of logins may be performed in other ways, for example, but not limited to,

$${f}_{1} ( F ) = \frac{1}{σ \sqrt{2 π}} {e}^{- \frac{{( F - μ )}^{2}}{2 {σ}^{2}}} .$$

The step of calculating the transaction risk value based on Equation (1) may further include the following sub-step:
using a logic equation

$$f ( x ) = \frac{2}{1 + {e}^{- ax}} - 1$$

to perform normalization on the time duration.

In this case, in Equation (1), ƒ₂(R) is

$${f}_{2} ( R ) = \frac{2}{1 + {e}^{- aR}} - 1 ;$$

where, a parameter a is determined by ƒ′₂(R=0)=K*ƒ′₂(R=R_P),
R_P=75 quantile, and K=100.

In one embodiment, a normalization curve of the time duration is shown in FIG. 4, and as the time duration from the first login of the terminal device to a current time increases, the normalization risk value presents a growing trend.

In addition, in some embodiments of the present disclosure, the normalization of the time duration may be performed in other ways, for example, but not limited to,

$${f}_{2} ( R ) = \frac{R - {R}_{min}}{{R}_{max} - {R}_{min}} .$$

The step of calculating the transaction risk value based on Equation (1) may further include the following sub-step:
using a logic equation

$$f ( x ) = \frac{2}{1 + {e}^{- ax}} - 1$$

to perform normalization on the total transaction amount.

In this case, in Equation (1), ƒ₃(M) is

$${f}_{3} ( M ) = \frac{2}{1 + {e}^{- ax}} - 1 ;$$

where, a parameter a is determined by ƒ′₃(M=0)=K*ƒ′₃(M=M_P), p1 M_P=99 quantile, and K=100.

In one embodiment, a normalization curve of the total transaction amount is shown in FIG. 5, and as the total transaction amount circulating in the terminal device increases, the normalization risk value presents a growing trend.

In addition, in some embodiments of the present disclosure, the normalization of the total transaction amount may be performed in other ways, for example, but not limited to,

$${f}_{3} ( M ) = \frac{M - {M}_{min}}{{M}_{max} - {M}_{min}} .$$

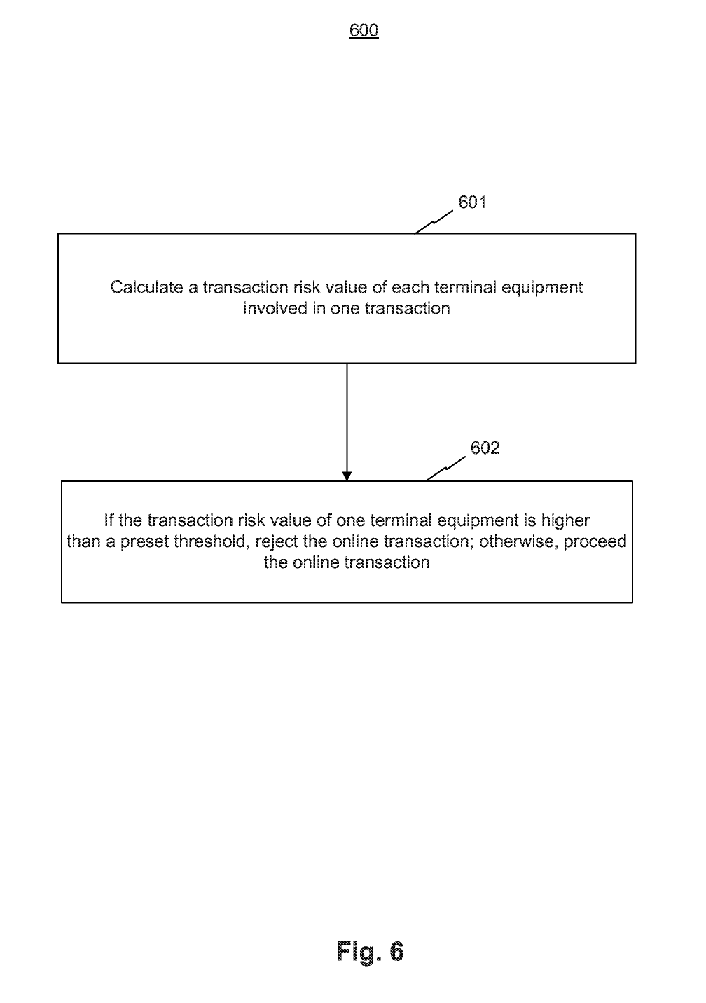

Consistent with some other embodiments of the present disclosure, an online transaction method is provided. FIG. 6 is a flow diagram of the online transaction method 600.

For example, as shown in FIG. 6, the online transaction method includes the following steps:

Step 601: calculate a transaction risk value of each terminal device involved in one transaction by using the methods provided in the above-described embodiments.

Step 602: if the transaction risk value of one terminal device is higher than a preset threshold, reject the online transaction; otherwise, proceed the online transaction.

As an example, the calculated transaction risk value may fall within a scope of 0-3. If the calculated transaction risk value is 3, the transaction is permitted. If the calculated transaction risk value is 2, other additional authentication modes can be added. If the calculated transaction risk value is 1, manual auditing may be requested. If the calculated transaction risk value is 0, the transaction may be rejected. The relation between the score of the transaction risk value and its corresponding operation authority can be set in other ways depending upon the requirements of the actual situations, which is not limited herein.

In this embodiment, based on the transaction risk value of each terminal device, the computer system controls the authority of the terminal device in performing online transactions, and that can effectively control the risks.

The method embodiments of the present disclosure can be implemented in a form of software, hardware, firmware, and so on. Regardless that the present disclosure is implemented in a form of software, hardware, or firmware, instruction codes can be stored in any type of computer accessible storage (for example, permanent or erasable, volatile or non-volatile, solid or non-solid, fixed or replaceable medium, etc.). Similarly, the storage may be, for example, Programmable Array Logic (PAL), Random Access Memory (RAM), Programmable Read Only Memory (PROM), Read-Only Memory (ROM), Electrically Erasable Programmable ROM (EEPROM), magnetic disc, optical disc, Digital Versatile Disc, (DVD), etc.

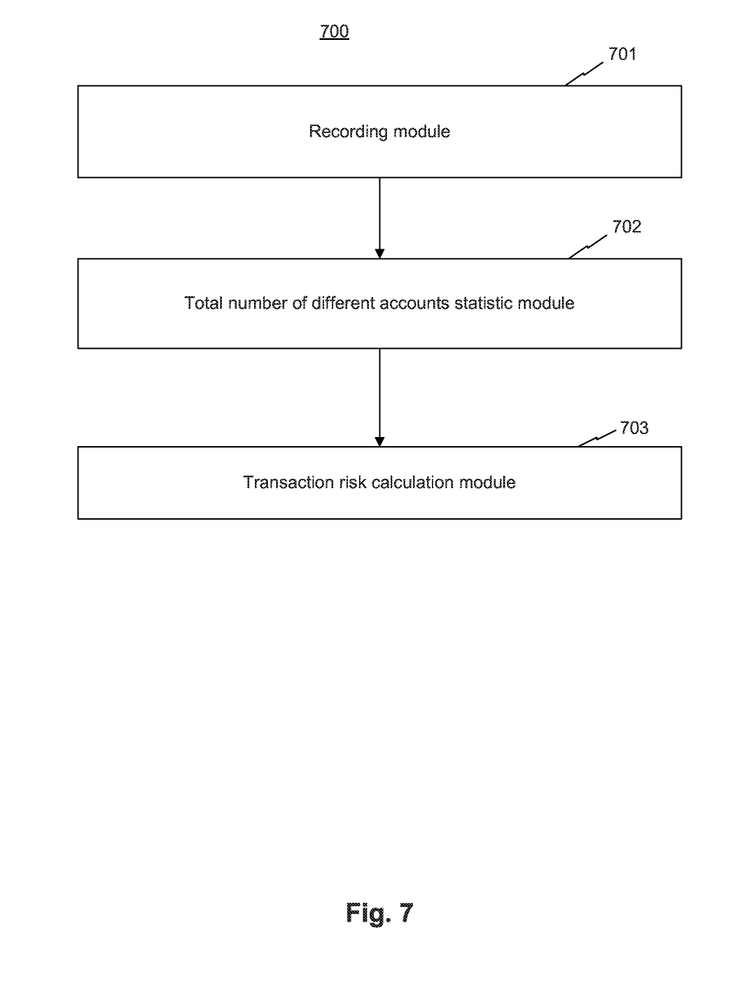

Consistent with some embodiments of the present disclosure, an apparatus for online transaction risk identification based on a computer system is provided. FIG. 7 is a block diagram of the apparatus 700 for online transaction risk identification based on a computer system. For example, as shown in FIG. 7, the apparatus for online transaction risk identification based on a computer system may include a recording module 701, for recording a corresponding relation between an identification of a terminal device and an account after the terminal device logs in the account, a total number of different accounts statistic module 702, for calculating a total number of different accounts logged in by the terminal device within a first predetermined period of time, based on the corresponding relation, and a transaction risk calculation module 703, for calculating, based on the total number of different accounts, a transaction risk value representing a transaction risk of using the terminal device to perform an online transaction. The apparatus 700 can implement the above-described methods. The detailed steps of the methods are not repeated here.

By means of information analysis and data modeling on terminal devices on the Internet used in online transactions, the apparatus can identify a risk value in the online transactions and fund management, and that can help guarantee users' fund security in online shopping or financing during the users' normal usage.

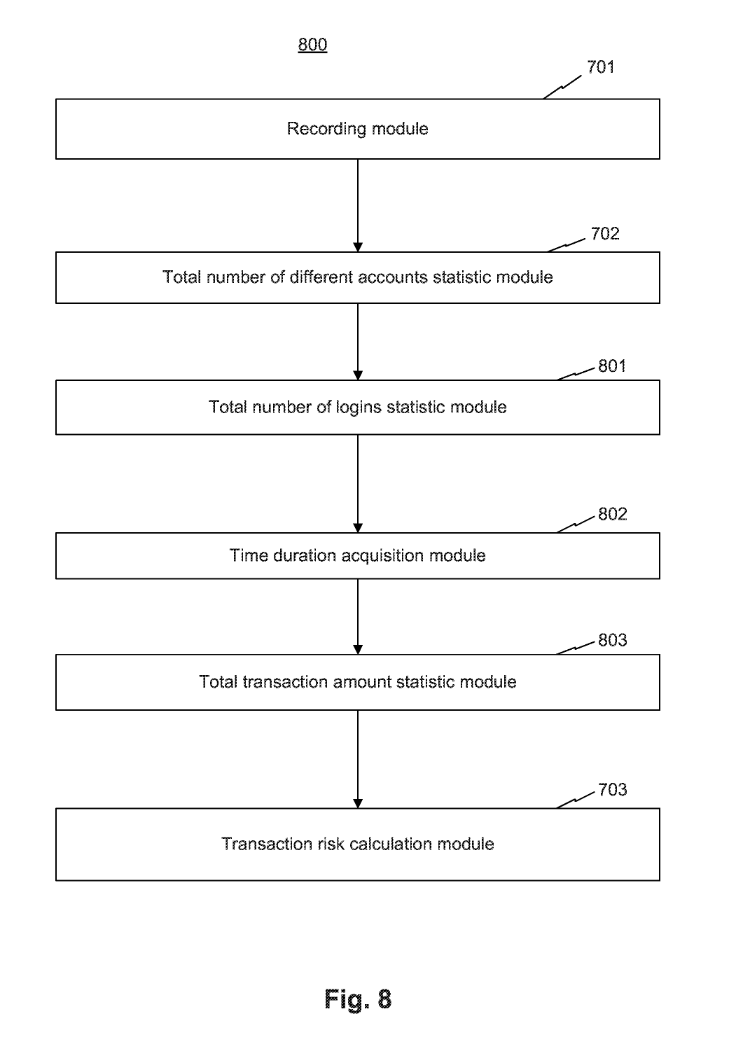

Consistent with some other embodiments of the present disclosure, an apparatus for online transaction risk identification based on a computer system is provided. FIG. 8 is a block diagram of the apparatus 800 for online transaction risk identification.

According to some embodiments, the apparatus 800, as shown in FIG. 8, besides a total number of different accounts, can further analyze a total number of logins of the terminal device within one time period, a total transaction amount, and a time duration from the first login to a current time, thereby obtaining a more accurate transaction risk value.

To implement these functions, the apparatus 800 may further include the following modules:
a total number of logins statistic module 801, for calculating a total number of logins at the terminal device within a second predetermined period of time;
a time duration acquisition module 802, for acquiring a time duration between a first login at the terminal device and a current time; and
a total transaction amount statistic module 803, for calculating a total transaction amount within a third predetermined period of time.

Correspondingly, the transaction risk calculation module 703 may calculate a transaction risk value based on the total number of different accounts and at least one of the total number of logins, the time duration, or the total transaction amount.

The apparatus 800 can implement the above-described methods. The detailed steps of the methods are not repeated here.

In some other embodiments, the apparatus 700 and 800 described above may comprehensively consider the total number of different accounts of the terminal device, the total number of logins within one time period, the time duration from the first login to a current time, and the total transaction amount circulating within one time period, and further consider a different weight of each of the above factors in calculating the transaction risk value, so that the calculated transaction risk value is more proper for the actual situation.

For example, the transaction risk value may be calculated in the transaction risk calculation module based on Equation (1).

$$Score = \frac{{a}_{1} \cdot {f}_{1} ( F ) + {a}_{2} \cdot {f}_{2} ( R ) + {a}_{3} \cdot {f}_{3} ( M )}{b \cdot {f}_{0} ( U )} \qquad ( 1 )$$

ƒ₁(F) and a₁ respectively represent a function of a total number of logins F and a weight thereof, f₂(R) and a₂ respectively represent a function of a time duration R and a weight thereof, ƒ₃(M) and a₃ respectively represent a function of a total transaction amount M and a weight thereof, and ƒ₀(U) and b respectively represent a function of a total number of different accounts U and a weight thereof.

For example, in the step of calculating the transaction risk value based on Equation (1), ƒ₀(U) is an exponential function ƒ₀(U)=pow (1.2, U−1), in which U represents the total number of different accounts, 1.2 is a base of the exponential function, and U−1 is an exponent of the exponential function.

The transaction risk calculation module may further include a total number of logins normalization sub-module, which uses a Chi-square distribution density curve function to perform normalization on the total number of logins.

In Equation (1), ƒ₁(F) is

$${f}_{1 k} ( F ) = \frac{{( 1 \text{/} 2 )}^{k / 2}}{Γ ( k \text{/} 2 )} {F}^{k / 2 - 1} {e}^{- F / 2} ,$$

where k represents a degree of freedom, F represents a total number of logins, and Γ represents Gamma function.

The transaction risk calculation module may further include a time duration normalization sub-module, for using a logic equation

$$f ( x ) = \frac{2}{1 + {e}^{- ax}} - 1$$

to perform normalization on the time duration.

In Equation (1), ƒ₂(R) is

$${f}_{2} ( R ) = \frac{2}{1 + {e}^{- aR}} - 1 ,$$

where a parameter a is determined by: ƒ′₂(R=0)=K*ƒ′₂(R=R_P), R_P=75 quantile, and K=100.

The transaction risk calculation module may further include a total transaction amount normalization sub-module, which uses a logic equation

$$f ( x ) = \frac{2}{1 + {e}^{- ax}} - 1$$

to perform normalization on the total transaction amount.

In Equation (1), ƒ′₃(M) is

$${f}_{3} ( M ) = \frac{2}{1 + {e}^{- aM}} - 1 ,$$

where a parameter a is determined by ƒ′₃(M=0)=K*ƒ′₃(M=M_P), M_P=99 quantile, and K=100.

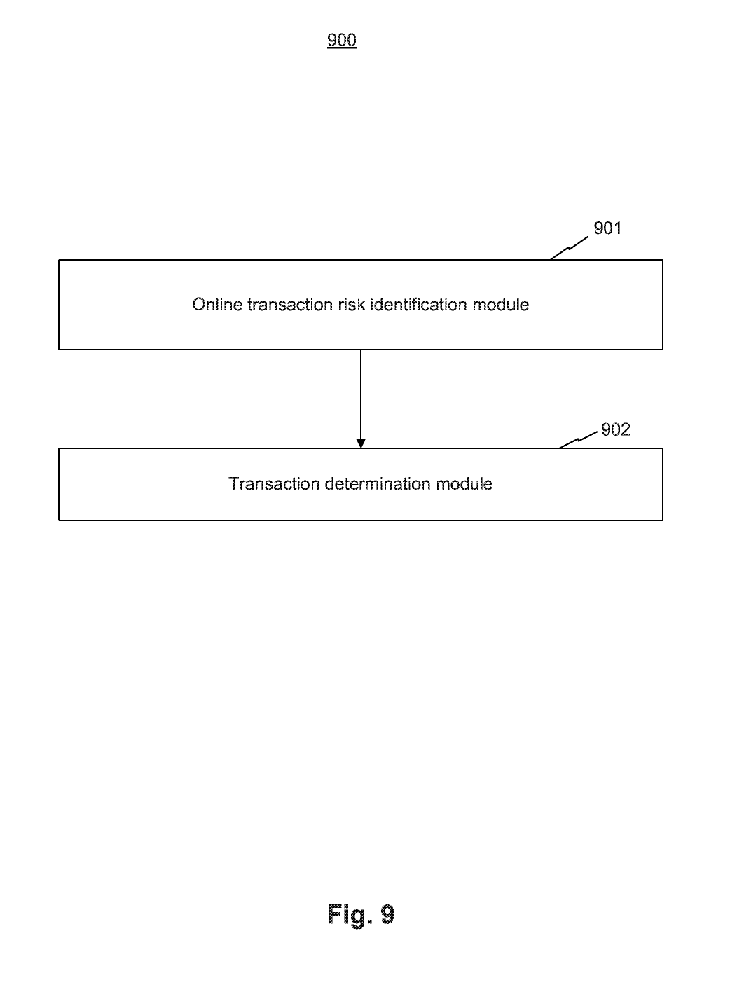

FIG. 9 is a block diagram of an online transaction apparatus 900 according to some other embodiments of the present disclosure.

The online transaction apparatus may include an online transaction risk identification module 901 and a transaction determination module 902. The online transaction risk identification module 901 calculates a transaction risk value of each terminal device involved in a transaction by using the apparatus described above.

The transaction determination module 902 determines whether to proceed with the transaction. For example, the transaction determination module 902 may reject the online transaction, if the transaction risk value of one terminal device is higher than a preset threshold; otherwise, proceed with the online transaction.

In addition, in some embodiments, the calculated transaction risk value may be set with a range of 0-3. If the calculated transaction risk value is 3, the transaction is permitted. If the calculated transaction risk value is 2, other additional authentication mode may be added. If the calculated transaction risk value is 1, manual auditing may be requested. If the calculated transaction risk value is 0, the transaction may be rejected. The relation between the score of the transaction risk value and its corresponding operation authority can be set in other ways depending upon the requirements of the actual situations, which is not limited herein.

In this embodiment, based on the transaction risk value of each terminal device, the apparatus controls the authority of the terminal device in performing online transactions, thereby effectively controlling the risks.

The embodiments of the present disclosure use big data technologies to analyze history operation records made by thousands of network subscribers in daily shopping payment and fund management on terminal devices on the Internet, build data modeling, identify potential risks in online transactions and fund management, and provide a score associated with the risk, to guarantee network subscribers' fund security in online shopping or financing.

The modules described in the apparatus embodiments of the present disclosure may be logic modules. One logic module may be one physical module, a part of one physical module, or a combination of a plurality of physical modules. In some other embodiments, the modules/units may be implemented in a form of software, hardware, firmware, or any combination of software, hardware, and firmware. For examples, the modules/units may be implemented by a processor executing software instructions stored in computer readable memories.

The specification has described methods, systems, and apparatus for identifying risks in online transactions. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” may include tangible items and exclude carrier waves and transient signals, i.e., be non-transitory. Examples include RAM, ROM, volatile memory, nonvolatile memory, hard drives, CD ROMs, DVDs, flash drives, disks, Programmable Array Logic (PAL), Programmable Read Only Memory (PROM), Electrically Erasable Programmable ROM (EEPROM), magnetic disc, optical disc, and any other known physical storage media.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for identifying risks in online transactions, comprising:
recording a corresponding relation between an identification of a terminal device and an account after the terminal device logs in the account;
calculating a total number of different accounts logged in by the terminal device within a first predetermined period of time, based on the corresponding relation; and
calculating, based on the total number of different accounts, a transaction risk value representing a transaction risk of using the terminal device to perform an online transaction.

2. The method of claim 1, before calculating the transaction risk value, further comprising:
calculating a total number of logins by the terminal device within a second predetermined period of time,
wherein calculating the transaction risk value comprises calculating the transaction risk value further based on the total number of logins.

3. The method of claim 1, before calculating the transaction risk value, further comprising:
acquiring a time duration between a first login by the terminal device and a current time,
wherein calculating the transaction risk value comprises calculating the transaction risk value further based on the time duration.

4. The method of claim 1, before calculating the transaction risk value, further comprising:
calculating a total transaction amount within a third predetermined period of time,
wherein calculating the transaction risk value comprises calculating the transaction risk value further based on the total transaction amount.

5. The method of claim 1, before calculating the transaction risk value, further comprising:
calculating a total number of logins by the terminal device within a second predetermined period of time;
acquiring a time duration between a first login by the terminal device and a current time; and
calculating a total transaction amount within a third predetermined period of time,
wherein calculating the transaction risk value comprises calculating the transaction risk value further based on the total number of logins, the time duration, and the total transaction amount.

6. The method of claim 5, wherein calculating the transaction risk value comprises calculating the transaction risk value further based on an equation
$$Score = \frac{{a}_{1} \cdot {f}_{1} ( F ) + {a}_{2} \cdot {f}_{2} ( R ) + {a}_{3} \cdot {f}_{3} ( M )}{b \cdot {f}_{0} ( U )} ,$$
with Score being the transaction risk value, F being the total number of logins, ƒ₁(F) being a function of the total number of logins F, a₁ being a weight of the function ƒ₁(F), R being the time duration, ƒ₂(R) being a function of the time duration R, a₂ being a weight of the function ƒ₂(R), M being the total transaction amount, ƒ₃ (M) being a function of the total transaction amount M, a₃ being a weight of the function ƒ₃(M), U being the total number of different accounts, ƒ₀(U) being a function of the total number U, and b being a weight of the function ƒ₀(U).

7. The method of claim 6, wherein ƒ₀(1.1) is an exponential function ƒ₀(U)=pow (1.2, U−1), 1.2 being a base of the exponential function, and U−1 being an exponent of the exponential function.

8. The method of claim 6, wherein ƒ₁(F) is a function
$${f}_{1 k} ( F ) = \frac{{( 1 \text{/} 2 )}^{k / 2}}{Γ ( k \text{/} 2 )} {F}^{k / 2 - 1} {e}^{- F / 2} ,$$
k being a degree of freedom, and Γ being a Gamma function.

9. The method of claim 6, wherein ƒ₂(R) is a function
$${f}_{2} ( R ) = \frac{2}{1 + {e}^{- aR}} - 1 ,$$
wherein a is determined by ƒ′₂(R=0)=K*ƒ′₂(R=R_P), R=P=75 quantile, and K=100.

10. The method of claim 6, wherein ƒ₃(M) is a function
$${f}_{3} ( M ) = \frac{2}{1 + {e}^{- aM}} - 1 ,$$
wherein a is determined by ƒ′₃(M=0)=K*ƒ′₃(M=M_P), M_P=99 quantile, and K=1.00.

11. The method of claim 1, further comprising rejecting the online transaction, if the transaction risk value exceeds a predetermined threshold.

12. An apparatus for identifying risks in online transactions, comprising:
a recording module configured to record an identification of a terminal device and a corresponding relation between the identification and an account after the terminal device logs in the account;
a total number of different accounts statistic module configured to calculate a total number of different accounts logged in by the terminal device within a first predetermined period of time, based on the corresponding relation; and
a transaction risk calculation module configured to calculate, based on the total number of different accounts, a transaction risk value representing a transaction risk of using the terminal device to perform an online transaction.

13. The apparatus of claim 12, further comprising:
a total number of logins statistic module configured to calculate a total number of logins by the terminal device within a second predetermined period of time,
wherein the transaction risk calculation module is further configured to calculate the transaction risk value based on the total number of logins.

14. The apparatus of claim 12, further comprising:
a time duration acquisition module configured to acquire a time duration between a first login by the terminal device and a current time,
wherein the transaction risk calculation module is further configured to calculate the transaction risk value based on the time duration.

15. The apparatus of claim 12, further comprising:
a total transaction amount statistic module configured to calculate a total transaction amount within a third predetermined period of time,
wherein the transaction risk calculation module is further configured to calculate the transaction risk value based on the total transaction amount.

16. The apparatus of claim 12, further comprising:
a total number of logins statistic module configured to calculate a total number of logins by the terminal device within a second predetermined period of time;
a time duration acquisition module configured to acquire a time duration between a first login by the terminal device and a current time; and
a total transaction amount statistic module configured to calculate a total transaction amount within a third predetermined period of time,
wherein the transaction risk calculation module is further configured to calculate the transaction risk value based on the total number of logins, the time duration, and the total transaction amount.

17. The apparatus of claim 16, wherein the transaction risk calculation module is further configured to calculate the transaction risk value based on an equation
$$Score = \frac{{a}_{1} \cdot {f}_{1} ( F ) + {a}_{2} \cdot {f}_{2} ( R ) + {a}_{3} \cdot {f}_{3} ( M )}{b \cdot {f}_{0} ( U )} ,$$
with Score being the transaction risk value, F being the total number of logins, ƒ₁(F) being a function of the total number of logins F, a₁ being a weight of the function ƒ₁(F), R being the time duration, ƒ₂(R) being a function of the time duration R, a₂ being a weight of the function ƒ₂(R), M being the total transaction amount, ƒ₃(M) being a function of the total transaction amount M, a₃ being a weight of the function ƒ₃(M), U being the total number of different accounts, ƒ₀(U) being a function of the total number U of different accounts, and b being a weight of the function ƒ₀(U).

18. The apparatus of claim 17, wherein ƒ₀(U) is an exponential function ƒ₀(U)=pow (1.2, U−1), 1.2 being a base of the exponential function, and U−1 being an exponent of the exponential function.

19. The apparatus of claim 17, wherein ƒ₁(F) is a function
$${f}_{1 k} ( F ) = \frac{{( 1 \text{/} 2 )}^{k / 2}}{Γ ( k \text{/} 2 )} {F}^{k / 2 - 1} {e}^{- F / 2} ,$$
k being a degree of freedom, and Γ being a Gamma function.

20. The apparatus of claim 12, further comprising a transaction determination module configured to reject the online transaction, if the transaction risk value exceeds a predetermined threshold.
